(19) United States
(12) Patent Application Publication
(10) Pub. No.: US 2004/0129175 A1
(43) Pub. Date: Jul. 8, 2004

(54) Fine particle size lime slurries and their production

(76) Inventors: Martin Peter Butters, West Yorkshire (GB); Gloria McLeod, West Yorkshire (GB)

Correspondence Address: CIBA SPECIALTY CHEMICALS CORPORATION, PATENT DEPARTMENT, 540 WHITE PLAINS RD, P O BOX 2005, TARRYTOWN, NY, 10591-9005, US

(21) Appl. No.: 10/475,484

(22) PCT Filed: May 2, 2002
(86) PCT No.: PCT/EP02/04782

(30) Foreign Application Priority Data
May 14, 2001 (GB) 0111706.8

(51) Int. Cl. C09C 1/02

(52) U.S. Cl. 106/461

(57) ABSTRACT

Calcium hydroxide slurries and processes for their production, that have lower mean particle-sizes than otherwise equivalent slurries produced using alternative processes or whereby the mean particle-size is reduced more efficiently than when using alternative processes to produce otherwise equivalent slurries.

This invention relates to a process for producing calcium hydroxide slurries that have lower mean particle-sizes than otherwise equivalent slurries produced using alternative processes or whereby the mean particle-size is reduced more efficiently than when using alternative processes to produce otherwise equivalent slurries. Slurries so produced also possess low viscosity and good stability to settlement.

Calcium hydroxide slurries can be produced from the dispersion of lime hydrate (calcium hydroxide) in water or from the slaking of quicklime (calcium oxide) with water to produce slaked lime slurry, otherwise known as milk of lime. Such slurries are used in a range of applications, including the removal of sulphur compounds from flue gases in wet absorption processes, the neutralisation of liquid effluents, as agricultural treatments for providing calcium to crops and for controlling soil pH, in potable water treatments and in sugar refining processes. In these applications the calcium hydroxide must react rapidly. The rate of reaction is higher when the mean particle size of the calcium hydroxide is low due to the higher surface area available for the reaction. It is also necessary that the slurries are low in viscosity and are stable against settlement. In addition it is often desirable that the slurries are high in solids content to minimize the costs associated with transportation of slurry.

It would be desirable to produce calcium hydroxide slurries of finer particle-size than would normally be achieved from conventional processes that do not employ mechanical particle-size reduction techniques or to produce calcium hydroxide slurries of finer particle-size more efficiently when employing mechanical particle-size reduction techniques. It is also desirable to produce slurries that possess low viscosity, good stability and, where desired, high solids content.

Accordingly the present invention provides a process for preparing such slurries that involves the use of 0.05 to 5% by weight based on weight of calcium hydroxide of a base and the use of 0.05 to 5% by weight based on weight of calcium hydroxide of a water soluble acidic polymer or water soluble salt or partial salt. Slurries so produced have a mean particle-size of 0.2 to 50 microns and comprise 15 to 75% by weight of calcium hydroxide.

Slurries produced from the process contain from 15 to 75% calcium hydroxide, specifically 25 to 65% and most preferably from 35 to 55%.

The amount of polymer is preferably 0.05-5%, preferably 0.1 to 3% and most preferably 0.2%-2% by weight based on weight of calcium hydroxide.

The base may be an alkali metal hydroxide, an ammonium hydroxide, an alkali metal carbonate, an ammonium carbonate or a combination of these bases.

The base is preferably sodium or ammonium hydroxide, sodium or ammonium carbonate or a combination of these two bases.

The base is most preferably sodium hydroxide. The amount of base is preferably 0.05-5%, preferably 0.1 to 3% and most preferably 0.2%-2% by weight based on weight of calcium hydroxide.

Slurries produced from the process have a mean particle-size from 0.5-50 microns, preferably 0.5-20 microns and most preferably 0.5-10 microns. The mean particle size of the calcium hydroxide particles may be measured by any known means of analysis.

Polymers based on the following product types may be used for preparing the Calcium Hydroxide slurry:

a) homopolymers and copolymers prepared from addition polymerisation

b) anionic condensation polymers

c) polymers derived from natural sources e.g. anionic polysaccharides from starches etc.

Useful group a) polymers prepared by addition polymerisation could be defined as polymers prepared using at least one ethylenically unsaturated monomer containing at least one acidic or anionic functional group, such as carboxylic acid groups, sulphonic acid groups etc. Homopolymers would, of course, be prepared from just one monomer containing an acidic or anionic functional group. Copolymers would be prepared from two or more monomer types, at least one of which contains an acidic or anionic functional group.

Homopolymers may be prepared using one acidic monomer such as acrylic acid, methacrylic acid, maleic acid, maleic anhydride, fumaric acid, itaconic acid, itaconic anhydride, aconitic acid, crotonic acid, isocrotonic acid, mesaconic acid, vinyl acetic acid, hydroxyacrylic acid, undecylenic acid, allyl sulphonic acid, vinyl sulphonic acid, allyl phosphonic acid, vinyl phosphonic acid, 2-acrylamido-2-methyl propanesulphonic acid or 2-acrylamidoglycolic acid

Copolymers are prepared using at least one monomer from the above group and optionally one or more non-acidic monomers such as acrylamide, acrylic acid esters, acrolein, methacrylic acid esters, maleic acid esters, itaconic acid esters, fumaric acid esters, vinyl acetate, acrylonitrile, styrene, alpha-methyl styrene, N-vinyl pyrrolidone, 2-hydroxyethyl acrylate, 2-hydroxyethyl methacrylate, dimethyl acrylamide, N-(hydroxymethyl)acrylamide or vinyl formamide.

Polymers useful in this invention will be in the form of the water-soluble free acid partial or full alkali metal or ammonium salt or mixed salt. Preferred anionic polymers are made from acrylic acid (water soluble free acid, partial or full salt) with one other monomer selected from acrylamide, dimethylacrylamide, methacrylic acid, maleic acid or AMPS (sodium salts) in a preferred composition of 100:0 to 50:50 (on a weight basis) and in the form of the free acid, partial or full sodium salt. More preferred anionic polymers include polyacrylic acid in the form of the free acid, partial or full sodium salt.

Polymers useful in this invention have a weight average molecular weight (Mw) of from about 1,000 to about 250,000 as measured by aqueous gel permeation chromatography (gpc). Where “Mw” appears, it refers to the Mw as measured by aqueous gpc. Preferred polymers have a weight average molecular weight of from 2,000 to 100,000 more preferred are polymers having a weight average molecular weight of from 3,000 to 10,000.

The method of preparing such polymers is well known to those skilled in the art. The anionic addition polymers can be prepared by organic solvent, aqueous, or organic solvent/aqueous processes. The art of preparing anionic polymers has also employed various methods of controlling the molecular weight of polymers. These methods include the use of chain transfer agents, metal activators such as Fe²⁺ in redox initiator systems, control of reaction time and monomer concentration, increased levels of initiators etc.

The slurry preparation process of the invention may be operated in a number of ways.

One example of the process involves the addition of hydrated lime (calcium hydroxide) to water in a vessel with agitation applied before and/or during the addition of hydrated lime and continued after the addition of hydrated lime to a point when the slurry becomes homogenous.

Examples of the process include the slaking of quicklime (calcium oxide) in water in one or more slaking steps. In an example involving one slaking step, quicklime may be added to water in a vessel under controlled conditions to give the final calcium hydroxide slurry. In an example involving two or more slaking steps, the first slaking step may involve the addition of a portion of the total quicklime to a portion of the total water in a vessel until the slaking reaction is advanced or complete. A second portion of water may then be added to the vessel followed by the addition of a second portion of quicklime in a second slaking step. Further slaking steps may be carried out. Another example of a slaking process involves the continuous addition of quicklime to a portion of water in a vessel. The remaining portion of water may be added to the vessel in a single addition or in a number of additions or in a continuous feed during or during and after the addition of quicklime. In these examples of slaking processes, agitation may be applied before and/or during and after the addition of quicklime. Agitation may be continued to a point when all of the water has been added and the slaking reaction is advanced or complete and when the slurry becomes homogenous.

Examples of the process also include the use of both hydrated lime and quicklime to produce calcium hydroxide slurries. One such example is the addition of hydrated lime to a slurry produced from the slaking of quicklime in water. Another example is the addition of quicklime to a hydrated lime slurry with sufficient water present to allow the conversion of the quicklime to calcium hydroxide in a slaking reaction and to give a slurry of the desired calcium hydroxide solids content. In yet another example, a slurry produced from hydrated lime is blended with a slurry produced by the slaking of quicklime, or visa versa, to give the final calcium hydroxide slurry.

The process, such as in the examples disclosed, could include a milling step or other mechanical particle-size reduction step to facilitate the reduction in mean particle-size. Such a step may be employed during and/or after the addition of hydrated lime or quicklime.

The process, such as in the examples disclosed, may involve dissolving the polymer(s) and base(s) in the water in the vessel before commencing the addition of hydrated lime or quicklime or the polymer(s) and base(s) may be added to the vessel in a single addition or in a number of additions or in a continuous feed before and/or during and/or after the addition of hydrated lime or quicklime. A portion of the polymer(s) and/or base(s) may be dissolved in the water in the vessel before commencing the addition of hydrated lime or quicklime. The remaining polymer(s) and/or base(s) may then be added to the vessel in a single addition or in a number of additions or in a continuous feed before and/or during and/or after the addition of hydrated lime or quicklime. Some of the water to be used in process may be used to prepare convenient solutions of the polymer(s) and/or base(s) to be added in the process. In a slaking process that involves more than one slaking step or involves the continuous addition of quicklime to a portion of water in the vessel, the polymer(s) and/or base(s) may be dissolved in one or more of the portions of water so that the polymer(s) and/or base(s) are added to the vessel with the water. A particulate solid base and/or particulate solid polymer may be mixed with the hydrated lime or quicklime followed by the addition of the mixture to the vessel so that the base and/or polymer are added to the vessel with the hydrated lime or quicklime. A combination of these various examples of polymer and base additions may be used. Polymer(s) may be added at the same or at different points in the process to the base(s).

In the process, such as in the examples disclosed, polymer and base may be added individually or as a single solution of polymer and base. When more than one polymer and/or more than one base is used, each polymer and base may be added individually or as a solution of polymers and a solution of bases or as a single solution of polymers and bases. A combination of these addition options could be used. Polymer(s) may be used that are in the free acid form or partial salt form and in such cases a quantity of base(s) may be used that allows for the reaction of a proportion of the base(s) in the neutralisation of the free acid or partially neutralised polymer(s).

The process, such as in the examples disclosed, may be a batch process, semi-continuous process or continuous process.

The present invention relates to processes for producing calcium hydroxide slurries that have lower mean particle-sizes than otherwise equivalent slurries produced using alternative processes or whereby the mean particle-size is reduced more efficiently than when using alternative processes to produce otherwise equivalent slurries. Slurries so produced also possess low viscosity-and good stability. Particle-size, viscosity and stability may be determined using well known methods.

For example, the particle size of the slurry may be determined using a particle size analyser such as a Malvern Mastersizer. Viscosity may be determined using a Brookfield LVT viscometer, spindle 3 at 60 r.p.m. and the stability of the slurry may be measured using a technique that measures the amount of slurry that flows from a container after a period of storage (% Recovery).

A further aspect of this invention provides a calcium hydroxide slurry of mean particle-size 0.2-50 microns, whereby the slurry comprises calcium hydroxide at 15-75% by weight, anionic polymer at 0.05-5% by weight on weight of calcium hydroxide, base at 0.05-5% by weight on weight of dry calcium hydroxide and water to balance. The slurry according to the invention has a Brookfield LVT viscosity (measured using spindle 3 at 60 rpm) of 50-2000 cP, a % Recovery after 2 weeks (as determined by the method in Example 1) of greater than 80%, and a supematant layer after 2 weeks standing of less than 15% by volume of supernatant layer on total slurry volume.

The mean particle size of the slurry is preferably 0.5-20 microns and most preferably 0.5-10 microns.

The slurry may comprise 25-65% calcium hydroxide, most often 35-55% calcium hydroxide.

The slurry preferably comprises 0.1-3% by weight of anionic polymer, most preferably 0.2-2% by weight anionic polymer.

The slurry preferably comprises 0.1-3% by weight of base, most preferably 0.2-2% by weight of base.

The slurry preferably has a viscosity of 100-1000 cP and most preferably 150-750 cP,

The slurry preferably has a % recovery greater than 85% and most preferably greater than 90%.

The slurry preferably has a supernatant layer after 2 weeks standing of less than 10% by volume of supernatant layer on total slurry volume, more preferably less than 5%.

The slurries may be utilised in various applications including:

(a) treatment of industrial wastewater to adjust the pH by neutralisation and improving clarification of waste water

(b) potable water softening neutralisation and impurity removal to produce drinking water

(c) flue gas desulphurization treatment of gases from industrial facilities, power plants, incinerators etc. Where the Calcium Hydroxide absorbs and neutralises sulphur oxide, reducing emission and improving the environment

(d) flocculation, i.e. settlement of suspended solids to aid recovery of clear water

### EXAMPLE 1

Hydrated lime (calcium hydroxide) powder was added evenly over a few minutes to a beaker containing deionised water, with agitation applied using a laboratory mixer at a speed sufficient to maintain a small vortex in the slurry. The weights of hydrated lime and water used were calculated to give a slurry with a solids content of 40% w/w. After the final addition of hydrated lime, the slurry was stirred for a further 15 minutes. The solids content of the slurry was determined using a dry weight method i.e. about 1 gram of slurry was weighed into an aluminum dish and the weight recorded to 4 decimal places (original weight). After drying for 1 hour at 110° C., the dish was reweighed to determine the weight of solids in the dish (final weight). The solids content of the slurry was calculated as follows:

% Solids=final weight/original weigh×100.

An average of two results was taken to give the actual solids content. The actual solids content was slightly above the target of 40.0% therefore the slurry was diluted with deionised water to a solids content of 40.0% w/w. The temperature of the slurry was adjusted to 25±1° C. The slurry was stirred for 2 minutes using a laboratory mixer at a speed sufficient, to produce a small vortex, before conducting the following tests:

Viscosity: The viscosity of the slurry was determined using a Brookfield LVT viscometer, spindle 3 at 60 rpm.

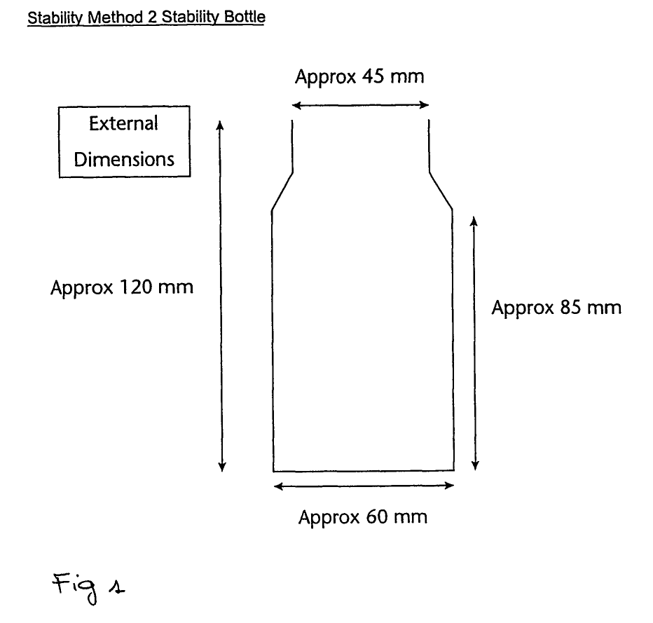

Stability: The stability of the slurry was determined as follows. The test included the use of a glass bottle with the approximate external dimensions as shown in FIG. 1.

Approximately 200 ml of slurry was placed into the glass bottle and the weight of slurry was recorded (Starting Weight). A cap was placed on the bottle and the bottle left undisturbed at room temperature for a period of 1 week in one test and two weeks in a second test. In both tests, when the storage time had elapsed the cap was removed from the bottle and the bottle inverted 180° directly over a pre-weighed beaker and the contents of the bottle allowed to drain for 2 minutes. During this draining period, the bottle was moved gently in an arc without sudden jerks. The weight of fluid collected was determined (Recovered Weight) and the Recovery (%) was calculated as follows:

%. Recovery=RW/SW×100 (RW=Recovered Weight, SW=Starting Weight)

The % Recovery is the proportion of original calcium hydroxide slurry that drained from the bottle after the period of storage and is therefore a measure of the slurry stability. The higher the % Recovery, the better the stability is deemed to be.

The degree of settlement was determined by observing the slurry in the stability test over a two week period. The height from the bottom of the bottle interior to the top of the slurry was measured immediately after adding the slurry to the stability bottle (Slurry Height). After two weeks, the height of any supernatant layer that may have formed was measured (Supernatant Height). The slurry was contained in the part of the bottle with vertical walls where height is proportional to volume. The volume percentage of supernatant in the slurry after two weeks was obtained as follows:

% Supernatant=Supernatant Height/Slurry Height×100.

The lower the % Supernatant, the lower the degree of settlement. A low level of settlement is preferred.

The particle size of the slurry was determined as follows.

20 cm³ of methanol was measured into a clean dry 100 cm³ glass bottle and 3 drops of the homogenised slurry was added. A cap was placed onto the bottle and the mixture was gently swirled to disperse the slurry. This was then placed in a sonic bath for exactly 1 minute.

The particle size distribution was determined using a Malvern Mastersizer Microplus Particle Size Analyser “RTM”. The software package used was version 2.18 and the method used was based around the guidelines laid out in the manuals supplied with the Malvern Mastersizer. This procedure was limited to a particle size range of 0.01-556 mm. The laser technique of particle size analysis assumes that all particles in the system were perfectly spherical and was therefore not comparable with results obtained from other methods of particle size such as sieve analysis. The particle size result obtained was also dependent upon the optical properties of the sample under test and the solvent in which it is dispersed.

The Malvern analysis technique used calculations which required the knowledge of the optical properties of the sample. This allowed the analysis model to generate quantitative results based upon the presentation code used. The presentation code used was Frauhofer and was calculated from the optical properties mentioned above. Samples of a similar nature can only be compared when an identical presentation code has been used to analyse the result

### EXAMPLE 2

A slurry was produced using the same procedure as described in Example 1 (above) except that hydrated lime was added to deionised water containing dissolved polyacrylic acid (sodium salt) at a level equivalent to 0.75% active polyacrylic acid (sodium salt) on a dry calcium hydroxide weight basis.

The molecular weight of the polyacrylic acid (sodium salt) had previously been determined using a Gel Permeation Chromatography (GPC) system that included a set of GPC columns comprising of a TSK PWXL guard column, a G4000 and G3000 column from Toso Haas Corporation, a differential refractive index detector, pump and column oven. The system included a computer with software for data collection, construction of calibration curves and determination of molecular weight data.

The operating conditions used for calibration and sample analysis involved the use of a mobile phase of 0.2M sodium chloride buffered with 0.005M dipotassium hydrogen phosphate (prepared in purified water), a flow-rate of 0.5 ml/minute and column temperature of 40° C. The system was calibrated with a range of 6 polyacrylic acid (sodium salt) standards of molecular weight within the range 1,000 to 800,000.

From the analysis of standards, the computer software constructed a calibration curve of retention time versus the logarithm of molecular weight (third order polynomial fit). The polyacrylic acid sample being analysed was diluted in mobile phase solution to an approximate concentration of 0.15% w/v. This solution was filtered through a 0.45 micron filter and then injected into the system for analysis. Data collection and determination of molecular weight data in the form of weight and number averages and polydispersity were handled by the computer software. Ethylene glycol was added to each sample to monitor and correct for minor changes in flow rate.

The following molecular weight data was obtained for polyacrylic acid (sodium salt) sample:

Weight average molecular weight (Mw) 5570

Number average molecular weight (Mn) 2850

Polydispersity (Mw/Mn) 1.95

Tests on the slurry were carried out using the procedures described in Example 1.

### EXAMPLE 3

A slurry was produced using the same procedure as described in Example 1 (above) except that hydrated lime was added to deionised water containing i) dissolved polyacrylic acid (sodium salt) sample (as used in example 2) at a level equivalent to 0.75% active polyacrylic acid (sodium salt) on dry calcium hydroxide weight basis and ii) dissolved sodium hydroxide at a level equivalent to 0.75% sodium hydroxide on a dry weight basis of calcium hydroxide.

Tests on the slurry were carried out using the procedures described in Example 1.

Results

| | | | | Mean | |
|---|---|---|---|---|---|
| | | 1 week | 2 week | Particle | % |
| Example | Viscosity | Recovery | Recovery | Size | Supernatant |
| No. | (cP) | (%) | (%) | (microns) | (%) |
| 1 | >2000 | 0 | 0 | 6.8 | 0 |
| 2 | 256 | 53.5 | 52.8 | 5.7 | 4.2 |
| 3 | 68 | 98.0 | 97.9 | 3.2 | 14.1 |

The results show that the slurry containing polyacrylic acid (sodium salt) and sodium hydroxide (Example 3) has a much lower mean particle size compared to the slurries that do not contain both additives (Examples 1 and 2). The slurry from Example 3 is also lower in viscosity (with greater potential to increase the solids content) and of superior stability compared to the slurries from Examples 1 and 2.

### EXAMPLE 4

In this example a 45% w/w calcium hydroxide slurry was prepared from a different calcium hydroxide sample to that used in Examples 1-3. The slurry was prepared using the inventive process. The water soluble acidic polymer used to prepare the slurry was a 40% w/w solution of polyacrylic acid in the form of the full sodium salt, with the following molecular weight properties as determined by the GPC technique described in Example 2:

Mw 4390

Mn 1840

Polydispersity 2.39

The slurry was prepared by the following method. Calcium hydroxide powder was weighed into a beaker and in a separate beaker an aqueous solution was prepared by dissolving the polyacrylic acid (sodium salt) and sodium carbonate into water. The amount of calcium hydroxide and amount of water used was that required to give a 45% w/w slurry. The amount of polyacrylic acid (sodium salt) used was equivalent to 0.5% by weight of dry polymer on weight of dry calcium hydroxide and the amount of sodium carbonate used was equivalent to 0.5% by weight of dry Na2CO3 on weight of dry calcium hydroxide. Calcium hydroxide powder was gradually added over a few minutes to the aqueous solution with agitation applied using a laboratory mixer at a speed sufficient to create a small vortex. Agitation was continued for 15 minutes after the final addition of calcium hydroxide. The solids content of the slurry was determined by a dry weight method as described in Example 1 and the slurry was then adjusted to exactly 45.0% w/w by addition of a small amount of water, followed by further stirring to give a homogenous slurry. The slurry properties were tested shortly after stirring after adjusting the slurry solids content to 45%. The viscosity was determined using a Brookfield LVT viscometer (spindle 3, 60 rpm) and a Brookfield RVT viscometer (spindle 3, 5 rpm). Other properties were measured using the procedures in Example 1.

The following results were obtained:

| | | 2 Week | 2 Week | Mean |
|---|---|---|---|---|
| Viscosity (cP) | Viscosity (cP) | Supernatant | Recovery | Particle-size |
| LVT 60 rpm | RVT 5 rpm | (%) | (%) | (microns) |
| 184 | 2820 | 3.8 | 94.1 | 8.46 |

1. A process for producing a composition comprising an aqueous slurry comprising from 15 to 75 percent by weight Calcium Hydroxide; from 0.05 to 5 percent by weight, based on the weight of Calcium Hydroxide, of at least one water-soluble acidic polymer or water-soluble salt thereof; and from 0.05 to 5 percent by weight, based on the weight of Calcium Hydroxide, of at least one base, wherein the mean particle size of the calcium hydroxide particles is from 0.2 to 50 microns.

2. A process according to claim 1 wherein the base is an alkali metal hydroxide, an ammonium hydroxide, an alkali metal carbonate, an ammonium carbonate or a combination of these bases.

3. A process according to claim 1 or 2 wherein the acidic polymer is in the form of a free acid, partial or full salt and is a homopolymer or copolymer of one or more of Acrylic acid, Methacrylic acid, Maleic acid, Maleic anhydride, Fumaric acid, Itaconic acid, Itaconic anhydride, Aconitic acid, Crotonic acid, Isocrotonic acid, Mesaconic acid, Vinyl acetic acid, Hydroxyacrylic acid, Undecylenic acid, Allyl sulphonic acid, Vinyl sulphonic acid, Allyl phosphonic acid, Vinyl phosphonic acid, 2-acrylamido-2-methyl propanesulphonic acid, 2-acrylamidoglycolic acid, Acrylamide, Acrylic acid esters, Acrolein, Methacrylic acid esters, Maleic acid esters, Itaconic acid esters, Fumaric acid esters, Vinyl acetate, Acrylonitrile, Styrene, a Methyl styrene, N-Vinyl pyrrolidone, 2-Hydroxyethyl acrylate, 2-Hydroxyethyl methacrylate, Dimethyl acrylamide, N-(hydroxymethyl)acrylamide or Vinyl formamide.

4. A process according to any of claims 1 to 3, wherein the acidic polymer or salt thereof has a weight average molecular weight of 1,000 to 250,000.

5. A calcium hydroxide slurry of mean particle-size 0.2-50 microns, whereby the slurry comprises calcium hydroxide at 15-75% by weight, anionic polymer at 0.05-5% by weight on weight of calcium hydroxide, base at 0.05-5% by weight on weight of dry calcium hydroxide and water to balance. The slurry according to the invention has a Brookfield LVT viscosity (measured using spindle 3 at 60 rpm) of 50-2000 cP, a % Recovery after 2 weeks (as determined by the method in Example 1) of greater than 80%, and a supernatant layer after 2 weeks standing of less than 15% by volume of supernatant layer on total slurry volume.
